(19) United States
(12) Patent Application Publication
(10) Pub. No.: US 2023/0291192 A1
(43) Pub. Date: Sep. 14, 2023

(54) HOLDING ASSEMBLY

(71) Applicant: GRIPPLE LIMITED, Sheffield, South Yorkshire (GB)

(72) Inventor: Oliver Sunderland, Sheffield, South Yorkshire (GB)

(21) Appl. No.: 18/008,368

(22) PCT Filed: Jun. 11, 2021
(86) PCT No.: PCT/IB2021/055142

§ 371 Date: Dec. 5, 2022

(30) Foreign Application Priority Data
Jun. 19, 2020 (GB) 2009393.6
May 26, 2021 (GB) 2107466.1

(51) Int. Cl. H02G 3/32; F16L 3/23; F16L 3/12; F16M 13/02

(52) U.S. Cl. CPC H02G 3/32; F16L 3/23; F16L 3/1218; F16M 13/022

(57) ABSTRACT

A holding assembly (12) comprises a support member (30) and an engaging member (32) for engaging an article (16) to be held. The engaging member (32) is mounted on the support member (30). The engaging member (32) has a substantially U-shaped covering portion (34) defining a space (36) to receive the article (16). The support member (30) has a substantially U-shaped holding portion (38). The covering portion (34) is provided on the holding portion (38).

This invention relates to holding assemblies. More particularly, but not exclusively, this invention relates to holding assemblies for holding elongate articles, such as electrical or data cables.

Electrical and data cables are often arranged in cable trays, suspended from roofs or ceilings in factories. Similarly, plastic pipes, such as lightweight condensate pipes can also be suspended from roofs or ceilings. However, the installation of such trays and pipes can be expensive and time consuming.

According to one aspect of this invention, there is provided a holding assembly comprising a support member and an engaging member for engaging an article to be held, the engaging member being mounted on the support member, wherein the engaging member has a covering portion defining a space to receive the article.

The covering portion may be substantially U-shaped.

The article supported by the holding assembly may be an elongate article, such as a cable or a pipe. The cable may be an electrical cable or a data cable.

The support member may have a holding portion. The holding portion may be substantially U-shaped. The covering portion may be provided on the holding portion of the support member.

The engaging member may be formed of a deformable material, whereby the engaging member is deformed to the shape of the holding portion to provide the covering portion.

The covering portion may be configured to correspond to the shape of the holding portion before being mounted on the support member.

The engaging member may be formed of a deformable material, whereby the covering portion is deformable to the shape of the holding portion.

The support member may comprise a skeleton of the holding assembly. The skeleton may form said holding portion.

The support member may be formed of an elongate member, such as a wire. The elongate member may be shaped, for example by bending, into the desired configuration.

The support member may be made by wire forming into the desired shape. The support member may be a wire form support.

The support member may comprise first and second substantially parallel elongate portions. The support member may comprise a cross portion extending between the elongate portions. The cross portion may be provided at one end of the support member.

The support member may comprise two of the cross portions. Each cross portion may be provided at a respective opposite end of the support member.

The support member may comprise a fastening portion for fastening the support member to a suspension member. The fastening portion may be receivable in a hole defined by the suspension member.

The support member may have first and second limbs. The holding portion may comprise the first and second limbs.

The fastening portion may be provided on the first limb of the support member. The fastening portion may comprise an insertion member for insertion into the aforesaid hole.

The insertion member may be offset from the first limb of the holding portion. The fastening portion may comprise a joining member to join the insertion member to the first limb of the support member. The fastening portion may have an end profile that is substantially L-shaped.

The covering portion may cover the support member. The covering portion may have a first surface on which the article can be arranged.

The covering portion may have a second surface. The first and second surfaces may be respective inner and outer surfaces.

The engaging member may comprise a fastening arrangement to fasten the engaging member to the support member. The fastening arrangement may be provided on the covering portion. The fastening arrangement may be provided on the second surface of the covering portion. The attaching arrangement may be provided on said outer surface of the covering portion.

The fastening arrangement may comprise a retaining member to retain the support member on the engaging member. The fastening arrangement may comprise a plurality of the retaining members. The fastening arrangement may comprise a pair of the retaining members. The retaining members may be arranged opposite one another on the covering portion.

The retaining members may engage one of the limbs of the support member. The retaining members may engage the first limb of the support member.

Thus, where the support member comprises first and second substantially parallel elongate portions, one retaining member of the pair of retaining members may engage one of the elongate portions, and the other retaining member of the pair of retaining members may engage the other of the elongate portions. Each of the retaining members may have a hook element.

The fastening arrangement may comprise a second retaining member between the aforesaid retaining members. The second retaining member may be a central second retaining member arranged between the retaining members. The elongate portions of the support member may be retained by engagement with a respective one of the retaining members and with the second retaining member.

The elongate portions may be snap fitted between the retaining members and the second retaining member. The elongate portions may be held by the hook elements, which hook over the elongate portions.

The second retaining member may have the configuration of a straight sided oval. The elongate portions may engage the straight sides of the second retaining member.

The fastening arrangement may further include a securing member to secure the engaging member in position on the support member. Thus, the securing member may prevent the engaging member moving along the support member.

The securing member may be provided on the second limb of the support member. The securing member may engage a region of the support member.

The securing member may comprise a hook element. The securing member may be secured to one of the limbs of the support member. The hook element may receive said region of the support member.

The securing member may comprise a barrier to maintain said region of the support member in the hook element. The aforesaid region of the support member may be one of the cross portions of the support member. The barrier may comprise a wall extending across the hook element.

The fastening arrangement may comprise an enclosure formation for containing an end region of the support member. The securing member may be provided within the enclosure formation.

The enclosure formation may comprise a wall extending around the hook element. The barrier may be a region of said wall.

The wall may define an opening through which the end region of the support member can be received. The opening may be defined opposite the barrier.

The engaging member may comprise an attaching arrangement for attaching the holding assembly to the suspension member. The attaching arrangement may be provided on the covering portion. The attaching arrangement may be provided on the second surface of the covering portion.

The attaching arrangement may comprise an attaching member. The attaching arrangement may comprise a plurality of attaching members. The attaching members may be arranged opposite one another on the covering portion.

The engaging member may have first and second limbs. The covering portion may have the first and second limbs.

The first limb of the engaging member may engage the first limb of the support member. The second limb of the engaging member may engage the second limb of the support member.

The attaching members may engage the suspension member. The attaching members may engage around the edges of the suspension member.

The attaching arrangement may comprise a pair of the attaching members. The attaching arrangement may comprise a plurality of pairs of the attaching members.

The attaching arrangement may comprise two pairs of the attaching members. The attaching arrangement may comprise three pairs of the attaching members. The attaching members of each pair of attaching members may be arranged opposite each other.

The attaching arrangement may comprise two pairs of the attaching members. The attaching arrangement may comprise a locating arrangement between each pair of attaching members to locate the suspension member between the attaching members. The locating arrangement may comprise a plurality of locating members.

The locating arrangement may comprise central locating members. The locating arrangement may comprise a pair of opposed central locating members. The locating arrangement may comprise upper locating members. The locating arrangement may comprise a pair of opposed upper locating members. The locating arrangement may comprise lower locating members. The locating arrangement may comprise a pair of opposed lower locating members.

Each central locating member may be arranged between the pairs of attaching members. One of the central locating members may be arranged adjacent one of the attaching members of each pair of attaching members. The other of the central locating members may be arranged adjacent the other fastening member of each pair of fastening members.

The central locating members may be arranged between the upper and lower locating members.

The fastening members may comprise snap fits, which may be cantilever snap fits.

The first limb of the engaging member may extend along the first limb of the support member. The second limb of the engaging member may extend along the second limb of the support member.

The engaging member may comprise a gate formation to allow the article to be received in the holding assembly. The gate formation may be pivotally connected to the covering portion.

The gate formation may be pivotally connected to the second limb of the engaging member. The gate formation may be movable between open and closed positions.

The gate formation may comprise a main part, which may be pivotally connected to the covering portion. The gate formation may comprise a locking member to lock the gate formation in the closed position.

The first limb of the engaging member may have a receiving formation to receive the locking member. The receiving formation may be a receiving aperture defined by the first limb.

The locking member may be substantially T-shaped, having a cross part and a linking part extending centrally from the cross part to the second limb of the engaging member.

The receiving aperture may have a wide region through which the cross part can be inserted. The receiving aperture may have a narrow region extending from the wide region, wherein the narrow region can receive the linking part.

Projections may extend from the first limb adjacent the narrow region to engage the cross part and lock the linking part in the narrow region.

The pivotal connection of the gate formation to the covering portion may urge the gate formation to the open position.

Thus, when the locking member is received by the receiving formation, the pivotal connection may urge the gate formation to the position in which the linking part of the locking member is locked in the narrow region, thereby locking the gate formation in the closed position.

According to another aspect of this invention, there is provided a suspension arrangement comprising a holding assembly as described above, and a suspension member on which the holding assembly is suspended.

The support member may be attached to the suspension member.

The suspension member may be elongate. The suspension member may define at least one hole. The suspension member may define a plurality of the holes.

The suspension member may comprise an elongate main portion. The main portion may be in the form of a substantially flat strip. The main portion may define the, or each, hole.

The suspension member may have a mounting portion for mounting the suspension article on a raised structure, such as a roof beam or ceiling. The mounting portion of the suspension article may extend transverse to the main portion.

The main portion may have a longitudinally extending main axis. The main portion may have an elongate central region extending along the main axis.

The central region may have a slight curvature. The central region may be curved about said main axis.

The main portion of the suspension article may have an elongate edge portion extending along the central region. The edge portion may be thicker than the central region. The edge portion may be folded to form a hemmed edge region of the main portion.

The main portion may have two of the edge portions arranged on opposite sides of the central region. Each of said edge portions may be folded to form respective hemmed edge regions of the main portion.

The holes may be arranged one after another along the main portion. The holes may be arranged one after another along the central region of the main portion. The, or each, hole may be a slot.

The engaging member may include a positioning arrangement to position the support member on the engaging member. The positioning arrangement may comprise positioning ribs. The positioning ribs may be provided on the covering member. The positioning ribs may be arranged between the elongate portions. In the embodiments described herein, the positioning ribs provide the advantage that they restrict the support member sliding relative the engaging member.

At least one embodiment of the invention will now be described by way of example only with reference to the accompanying drawings, in which:

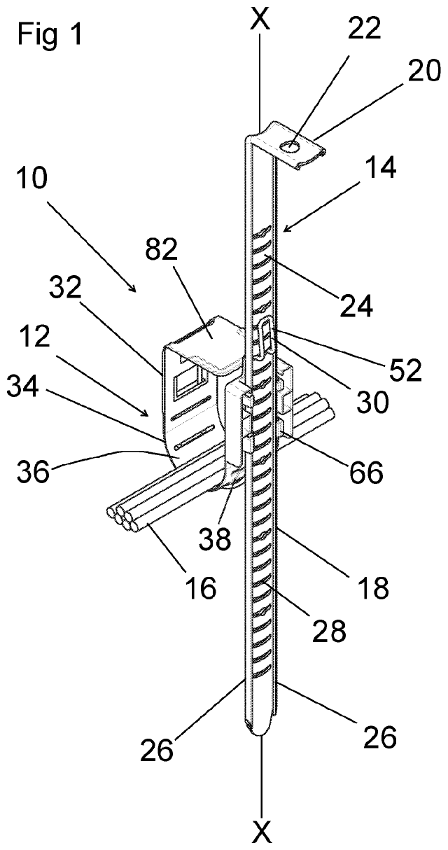

FIG. 1 is a rear perspective view of a suspension arrangement comprising a holding assembly holding a plurality of articles;

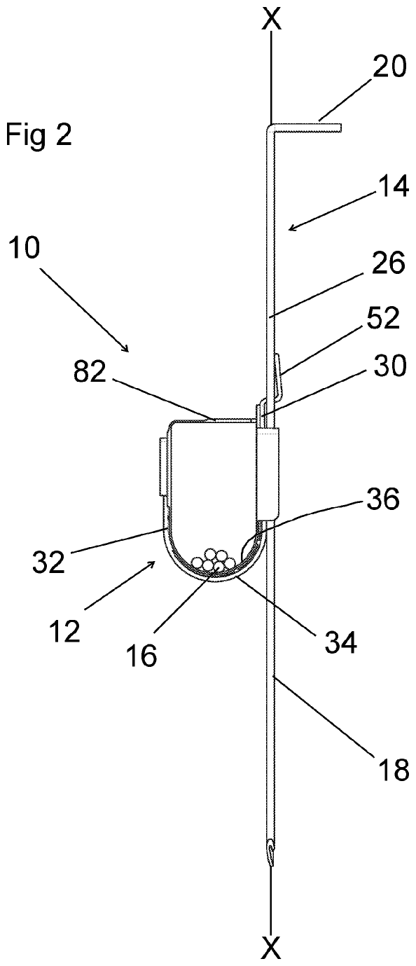

FIG. 2 is a side view of the suspension arrangement showing the holding assembly holding the plurality of articles;

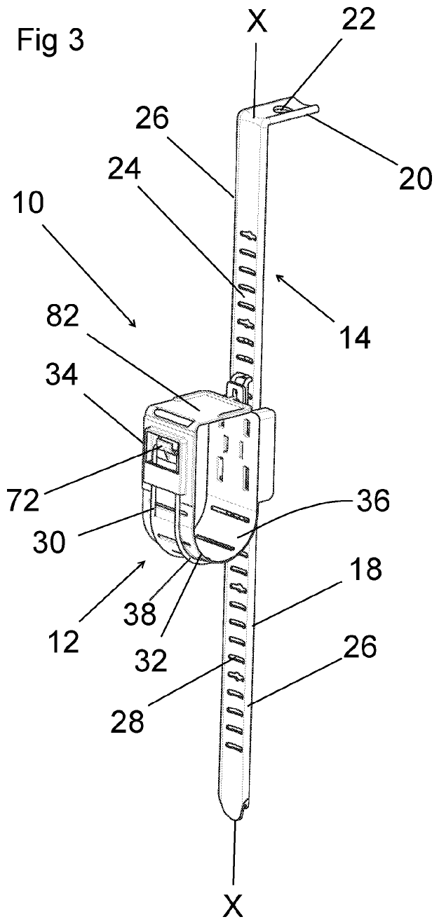

FIG. 3 is a front perspective view of the suspension arrangement;

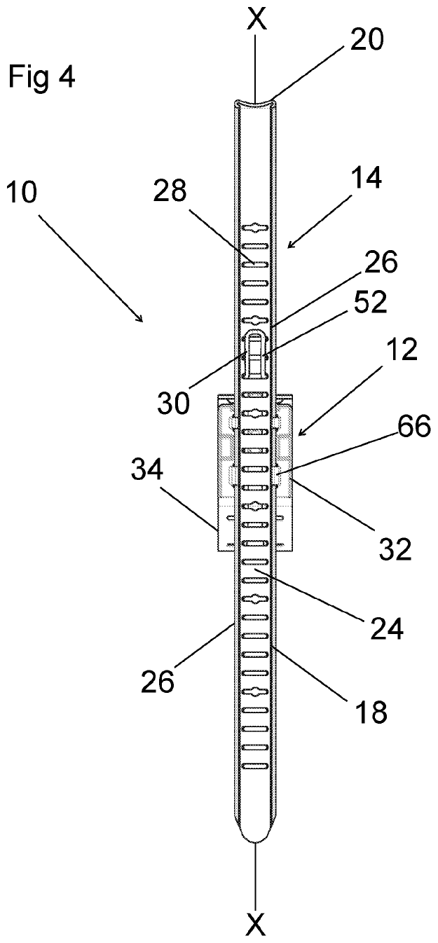

FIG. 4 is a rear view of the suspension arrangement;

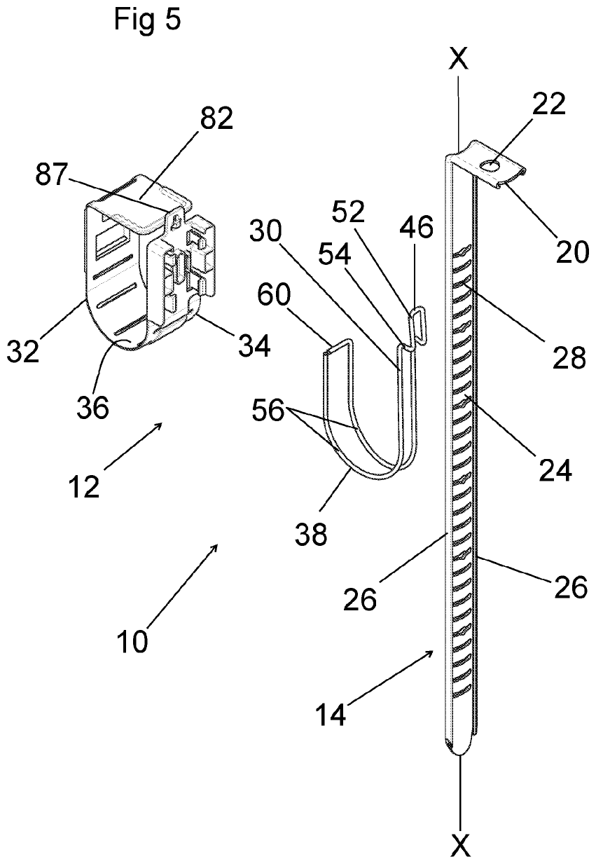

FIG. 5 is an exploded view of the suspension arrangement;

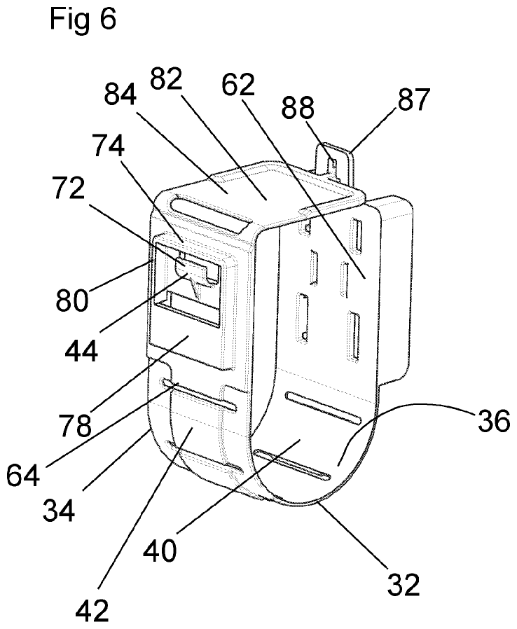

FIG. 6 is a front perspective view of an engaging member;

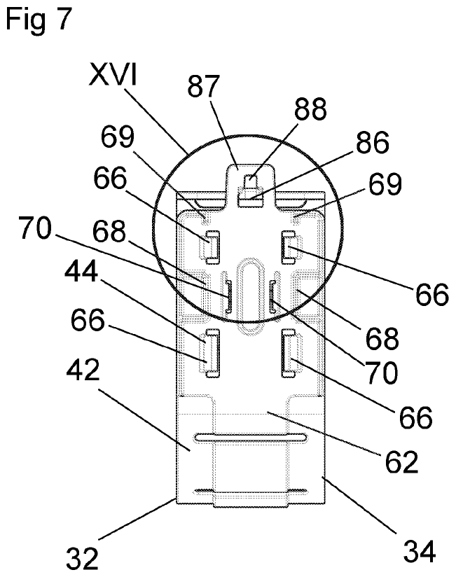

FIG. 7 is a rear view of the engaging member;

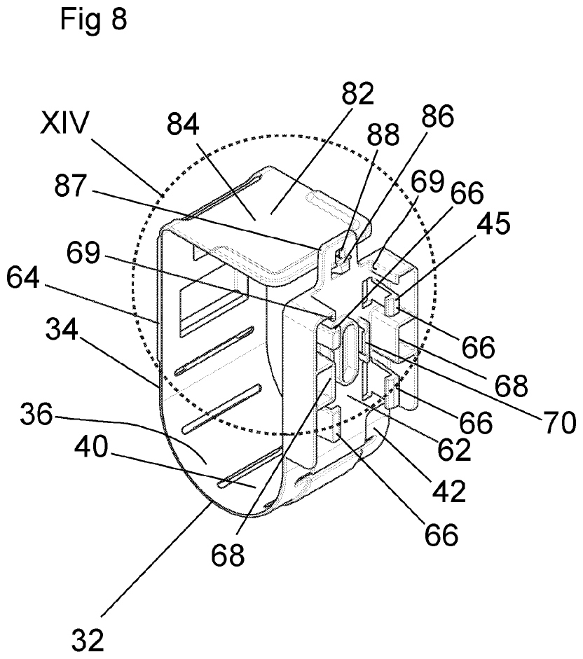

FIG. 8 is a rear perspective view of the engaging member;

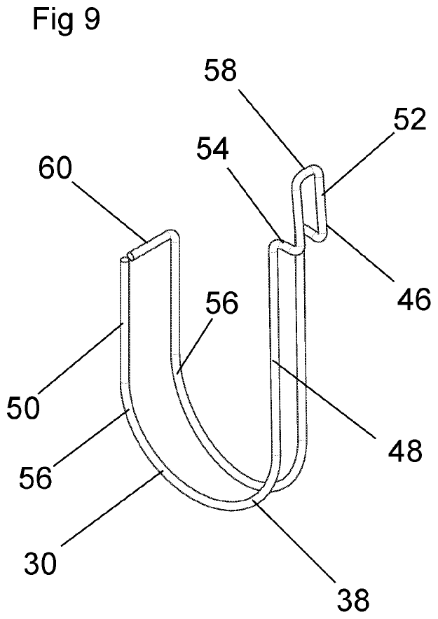

FIG. 9 is a rear perspective view of a support member;

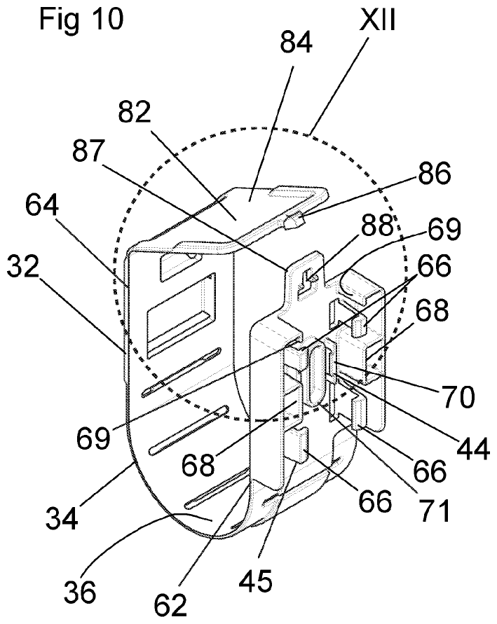

FIG. 10 is a rear perspective view of the engaging member in which a gate formation is in an open position;

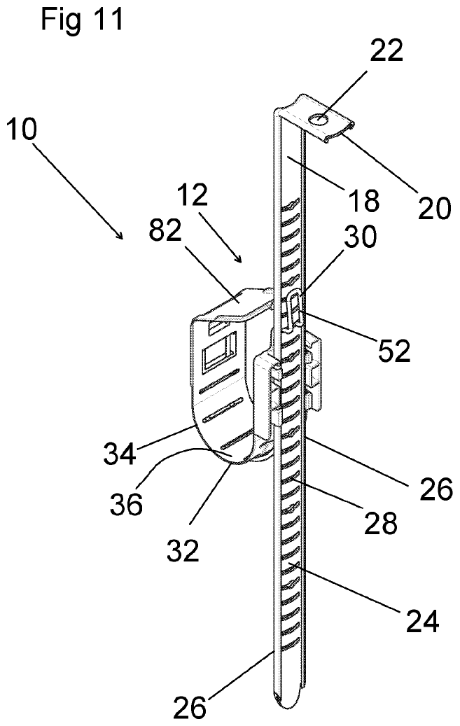

FIG. 11 is a perspective view of the holding assembly in which the gate formation is in an open position;

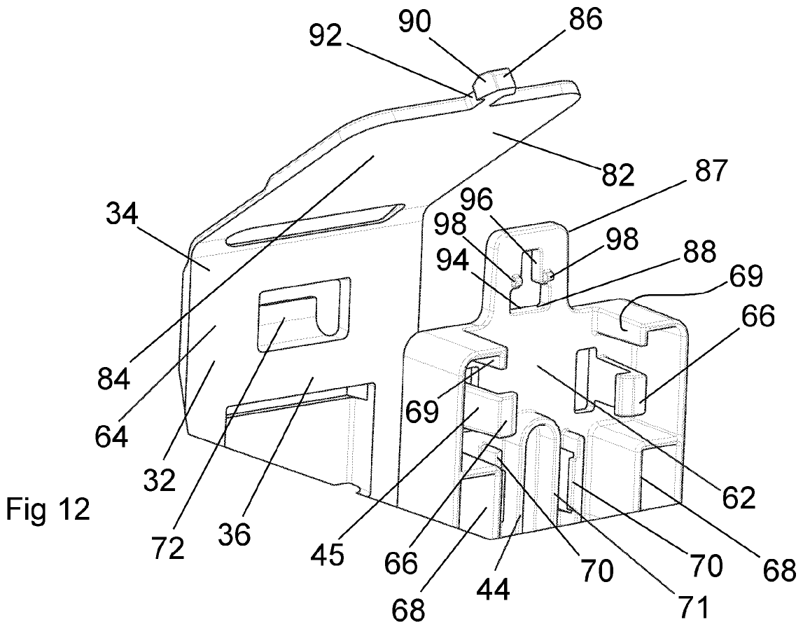

FIG. 12 is a close-up view of the region marked XII in FIG. 10;

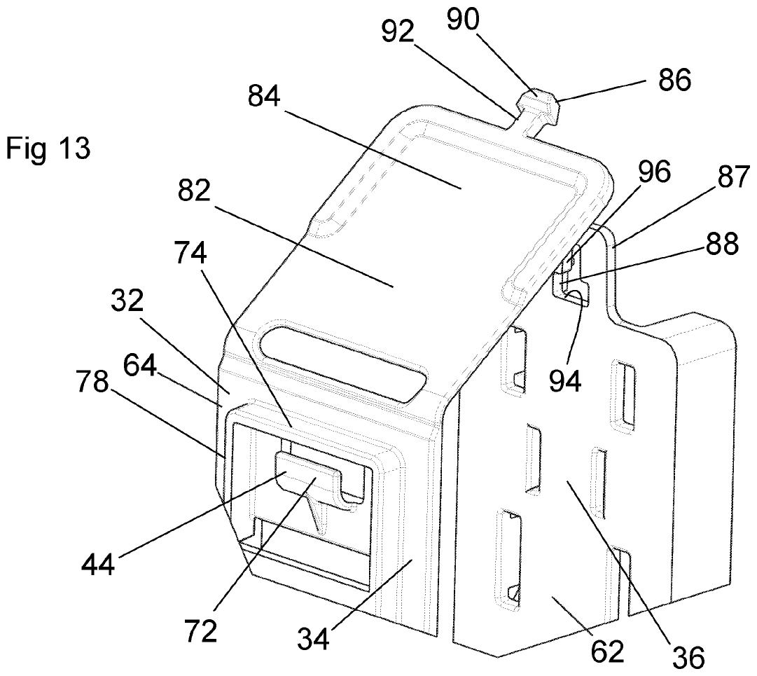

FIG. 13 is a close-up view of the same region as shown in FIG. 12, but from a different angle;

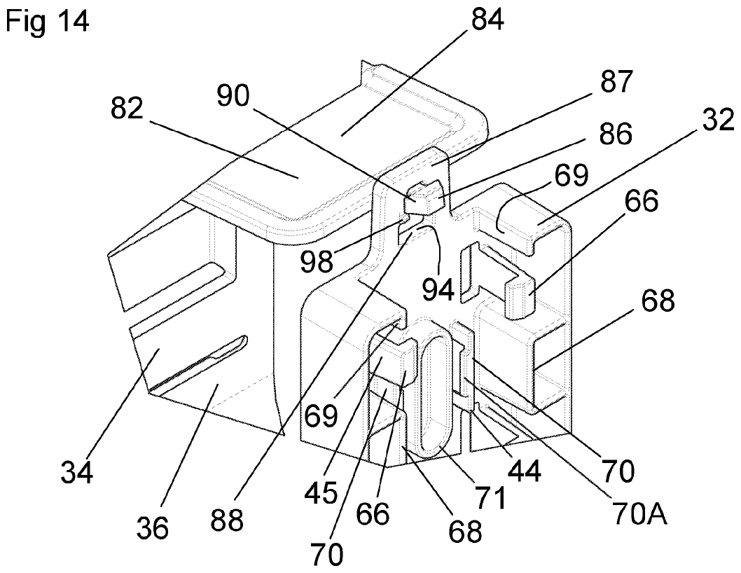

FIG. 14 is a close-up view of the region marked XIV in FIG. 8;

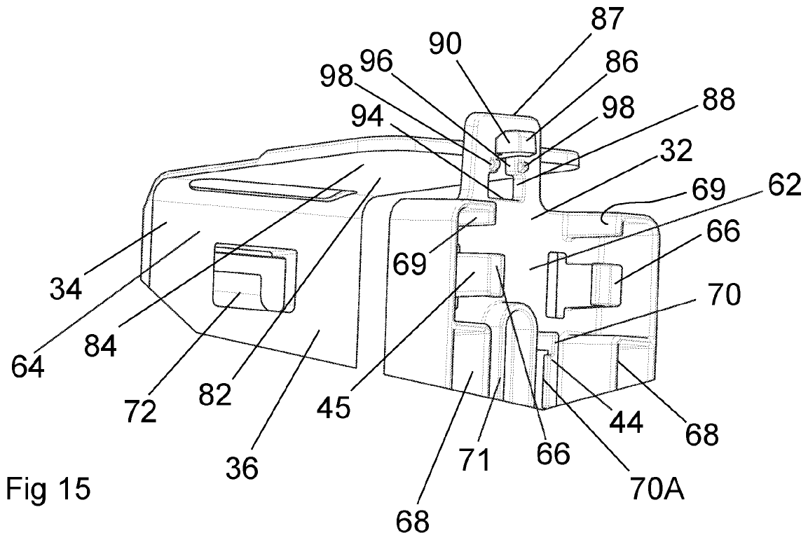

FIG. 15 is close-up view of the same region as shown in FIG. 14, but from a different angle; and

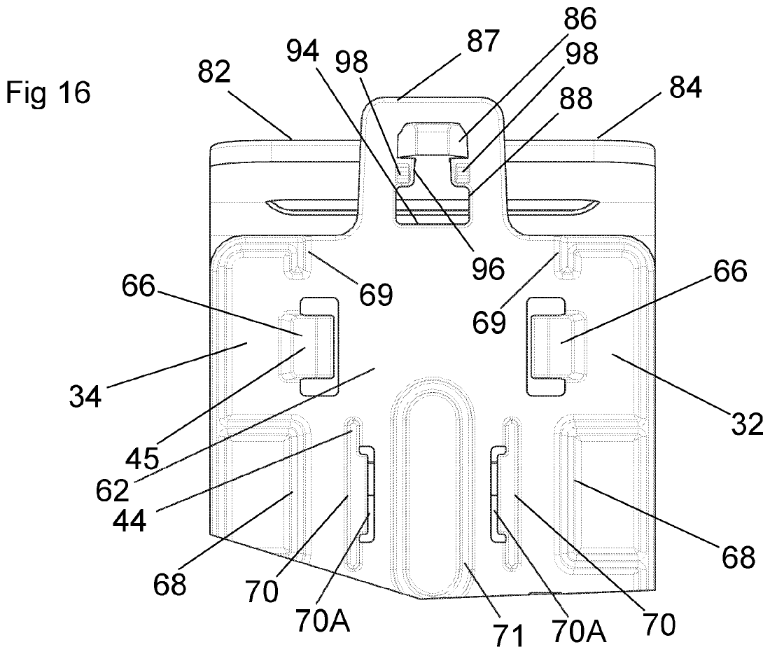

FIG. 16 is a close-up view of the region marked XVI in FIG. 7.

The drawings show a suspension arrangement 10 comprising a holding assembly 12 and a suspension member 14. The holding assembly 12 holds one or more articles 16. The articles 16 are elongate and may be in the form of a pipe or cables, such as electrical or data cables.

Referring to FIG. 1, one of the holding assemblies 12 is shown suspended from a suspension member 14 to form the suspension arrangement 10. The suspension member 14 comprises an elongate main portion 18 in the form of a substantially flat strip.

The suspension member 14 further includes a mounting portion 20 for mounting the suspension member 14 on a raised structure (not shown), such as a roof beam or ceiling.

A plurality of the suspension arrangements 10 may be arranged in a row spaced from each other, whereby the elongate articles 16 extend across all the suspension arrangements 10. Each suspension arrangement 10 comprises one of the holding assemblies 12 suspended from a respective suspension member 14.

The mounting portion 20 extends transverse to the main portion 18, for example at a right angle to the main portion 18. The mounting portion 20 defines a mounting hole 22 through which a screw or nail can be inserted to mount the suspension article 16 on the raised structure.

The main portion 18 has a longitudinally extending main axis X-X. An elongate central region 24 of the main portion 18 extends along the main axis X-X, and is curved about the main axis X-X.

The main portion 18 has opposite elongate edge regions 26 extending along the central region 24. Each of the opposite edge regions 26 of the main portion 18 is folded to form a hemmed edge. The combination of the curved main portion 18 and hemmed edge region 26 provide stability and strength to the suspension member 14.

The suspension member 14 defines a plurality of holes in the form of slots 28. Each slot 28 extends across the central region 24 of the main portion 18. The slots 28 are arranged one after another along the central region 24. The purpose of the slots 28 in the central region 24 of the main portion 18 is explained below.

The holding assembly 12 comprises a support member 30 and an engaging member 32 for engaging the articles 16. The engaging member 32 is mounted on the support member 30, so that the support member 30 acts as a skeleton, providing support for the engaging member 32.

The engaging member 32 comprises a substantially U-shaped covering portion 34 defining a space 36 to receive the articles 16. The support member 30 comprises a substantially U-shaped holding portion 38 (see FIG. 9) on which the covering portion 34 is mounted. The articles 16 engage the covering portion 34, and are supported thereon by the support member 30.

Referring to FIGS. 6, 7 and 8, the engaging member 32 is formed of a suitable deformable plastics material to allow the covering portion 34 to be deformed to the shape of the holding portion 38 of the support member 30. The covering portion 34 has opposite inner and outer surfaces 40, 42.

The inner surface 40 is smooth and faces the space 36 so that it engages the articles 16. The outer surface 42 is provided with a fastening arrangement 44 to fasten the engaging member 32 on the support member 30. The fastening arrangement 44 is described below.

The engaging member 32 further includes an attaching arrangement 45 for attaching the holding assembly 12 to the suspension member 14. The attaching arrangement 45 is also provided on the outer surface 42 of the covering portion 34.

As shown in FIG. 9, the support member 30 further includes a fastening portion 46 for fastening the support member 30 to a suspension member 14.

The support member 30 has first and second substantially parallel elongate portions 56, and first and second cross portions 58, 60 extending between the elongate portions 56.

The first and second cross portions 58, 60 are provided at respective opposite ends of the support member 30. The first cross portion 58 is provided at the fastening portion 46 at one end of the support member 30. The second cross portion 60 is provided at the opposite end of the support member 30.

The holding portion 38 has opposite first and second limbs 48, 50, each of the limbs 48, 50 being formed of adjacent elongate regions of the elongate portions 56. The fastening portion 46 extends from the first limb 48 of the holding portion 38, and comprises an insertion member 52 for insertion into a selected one of the slots 28 in the main portion 18 of the suspension member 14.

The fastening portion 46 comprises a joining member 54 to join the insertion member 52 to the first limb 48 of the holding portion 38. Thus, the fastening portion 46 is substantially L-shaped. The L-shape of the fastening portion 46 has the effect of offsetting the insertion member 52 from the first limb 48 of the holding portion 38.

The support member 30 is a wire form support manufactured by wire-forming a single wire into the desired shape. During manufacture, the wire is shaped, for example by bending, into the parallel elongate portions 56.

The parallel elongate portions 56 are shaped into the substantially U-shaped holding portion 38 and into the fastening portion 46.

The covering portion 34 also comprises first and second limbs 62, 64. The first limb 62 of the covering portion 34 extends along the first limb 48 of the holding portion 38. The second limb 64 of the covering portion 34 extends along the second limb 50 of the holding portion 38.

The attaching arrangement 45 comprises upper and lower pairs of attaching members 66 arranged on the first limb 62 of the covering portion 34. Each attaching member 66 comprises a cantilever snap fit.

The attaching members 66 of each pair are arranged opposite one another on the covering portion 34. One attaching member 66 of each pair of attaching members 66 engages one edge of the suspension member 14. The other attaching member 66 of each pair of attaching members 66 engages the other of the edges of the suspension member 14.

The attaching arrangement 45 further includes two central locating members 68 to locate the suspension member 14 between the attaching members 66 of each pair of attaching members. The attaching arrangement 45 further includes two upper locating members 69 aligned with the central locating members 68.

One of the central locating members 68 may be arranged adjacent and between one of the attaching members 66 of each pair of attaching members 66. The other of the central locating members 68 may be arranged adjacent and between the other attaching member 66 of each pair of attaching members 66.

In use, the central locating members 68 and the upper locating members 69 locate the suspension member 14 in a position between the attaching members 66. The central locating members 68 are arranged below the upper locating members 69.

The fastening arrangement 44 comprises a pair of retaining members 70 provided adjacent each of the central locating members 68. Each of the retaining members 70 has a hook element 70A (see FIG. 16). The fastening arrangement 44 further includes a central second retaining member 71 between the retaining members 70.

Each of the elongate portions 56 forming the first limb 48 of the holding portion 38 is received between a respective one of the retaining members 70 and the second retaining member 71. The elongate portions 56 are snap fitted into the spaces between the retaining members 70 and the second retaining member 71. The elongate portions 56 are held by the hook elements 70A, which hook over the elongate portions 56.

The second retaining member 71 has the configuration of a straight sided oval, wherein the elongate portions 56 engage the straight sides of the second retaining member 71.

The fastening arrangement 44 further includes a securing member 72 to secure the engaging member 32 in position on the support member 30. The securing member 72 comprises a hook element provided on the second limb 64 of the covering portion 34. The securing member 72 receives the second cross portion 60 of the support member 30.

The fastening arrangement 44 includes a barrier 74 to maintain second cross portion 60 in the securing member 72. Thus, when so secured by the securing member 72 and the barrier 74, the securing member 72 prevents the engaging member 32 moving along the support member 30.

The barrier 74 is part of an enclosure formation 78 for containing the end region of the support member 30. The securing member 72 is provided within the enclosure formation 78.

The enclosure formation 78 comprises a wall 80 extending around the securing member 72. The barrier 74 is a region of the wall 80. The wall 80 defines an opening through which the end region of the support member 30 can be received. The opening is defined opposite the barrier 74.

The engaging member 32 comprises a gate formation 82 to allow the article 16 to be received in the holding assembly 12. The gate formation 82 is pivotally connected to the second limb 64 of the covering portion 34, and is pivotally movable between open and closed positions.

The closed position of the gate formation 82 is shown in FIGS. 1 to 3, 5 to 8, and 14 to 16. The open position of the gate formation 82 is shown in FIGS. 10 to 13.

The gate formation 82 comprises a main part 84 and a locking member 86. The main part 84 has the pivotal connected to the covering portion 34. The locking member 86 locks the gate formation 82 in the closed position.

The first limb 62 of the covering portion 34 has a tab 87 defining a receiving aperture 88 to receive the locking member 86. The locking member 86 is substantially T-shaped, having a cross part 90 and a linking part 92 extending centrally from the cross part 90 to the second limb 64 of the covering portion 34. Thus, the locking member 86 is attached to the main part 84 of the gate formation 82 by the linking part 92.

The receiving aperture 88 has a wide region 94 through which the cross part 90 can be inserted. The receiving aperture 88 also has a narrow region 96 extending from the wide region 94. When the cross part 90 of the locking member 86 has been inserted into the wide region 94, the linking part 92 of the locking member 86 can then be moved into the narrow region 96 of the receiving aperture 88, so that the linking part 92 extends through the narrow region 96.

Projections 98 extend from the first limb 62 of the covering portion 34 adjacent the narrow region 96 to engage the cross part 90 and lock the linking part 92 in the narrow region 96.

The pivotal connection of the gate formation 82 to the covering portion 34 urges the gate formation 82 to the open position. Thus, when the locking member 86 is received by the receiving formation, the pivotal connection urges the gate formation 82 to the position in which the linking part 92 of the locking member 86 is locked in the narrow region 96, thereby locking the gate formation 82 in the closed position.

In use, the suspension member 14 is fastened to a roof beam or a ceiling, and the insertion member 52 is inserted through a selected one of the slots 28 in the suspension member 14.

When so inserted, as shown in FIGS. 1, 2 and 4, the insertion member 52 engages the main portion 18 of the suspension member 14, so that the joining member 54 extends through the aforesaid selected slot 28. As a result, the holding assembly 12 is supported by the engagement of the joining member 54 with the lower edge of said slot 28.

The locking member 86 can then be removed from the receiving aperture 88, and the gate formation 82 moved to the open position. The cables or other articles 16 can then be arranged in the space 36, and the gate formation 82 closed. The locking member 86 is then inserted into the receiving aperture 88 and secured thereto by moving the linking part 92 into the narrow region 96 of the receiving aperture 88.

The above steps can be repeated at each of a plurality of the holding assemblies suspended from the roof beam or ceiling.

There is thus described a holding assembly 12. A plurality of the holding assemblies 12 can be suspended from a roof beam or ceiling by means of a suspension member 14, thereby allowing an elongate article 16, such as an electric cable to be supported therefrom. The holding assembly 12 is easily installed, and allows easy access to the space 36 for the articles 16 to be held.

Various modifications can be made without departing from the scope of the invention.

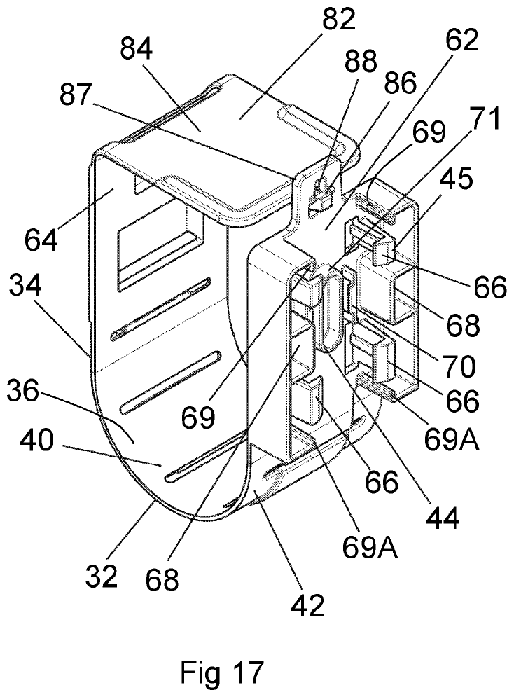

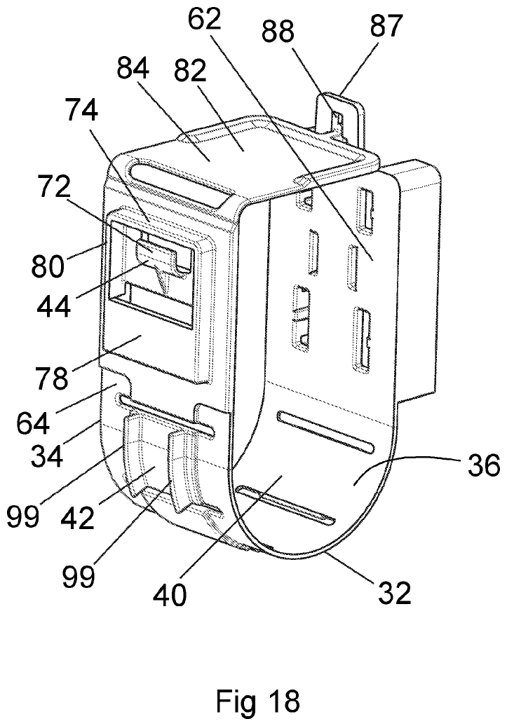

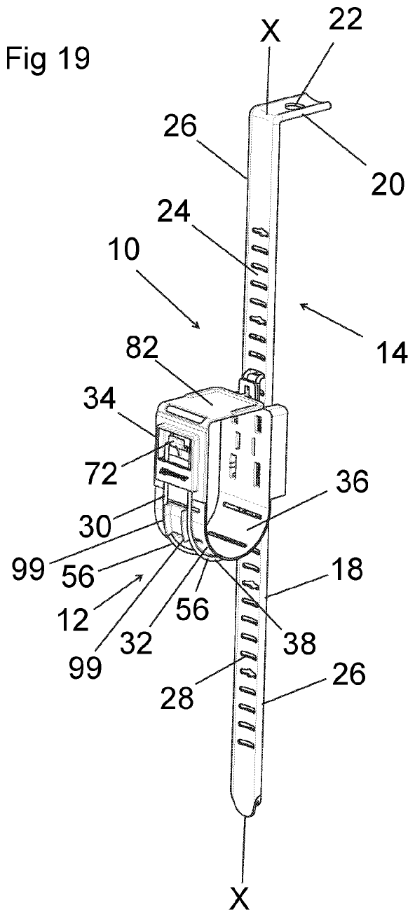

A further version of the engaging member 32 is shown in FIGS. 17, 18 and 19, which possesses all the features of the engaging member 32 shown in FIGS. 1 to 16. The features of the engaging member 32 shown in FIGS. 17 and 18 are designated with the same reference numerals as the corresponding features of the engaging member shown in FIGS. 1 to 16.

The attaching arrangement 45 shown in FIGS. 17, 18 and 19 additionally possesses lower locating members 69A below the central locating members 68. The lower locating members 69A are aligned with the central locating members 68.

The engaging member 32 shown in FIGS. 17,18 and 19 further includes two positioning ribs 99 on the covering member 34. The positioning ribs 99 are provided to position the elongate portions 56 on the engaging member 32. The positioning ribs 99 are arranged between the elongate portions 56 to prevent the support member 30 sliding off the engaging member 32.

1. A holding assembly comprising a support and an covering for engaging an article to be held, the covering being mounted on the support, wherein the a covering is substantially U-shaped and defines a space to receive the article, wherein the support has a substantially U-shaped portion, the covering portion being provided on the substantially U-shaped portion.

2. A holding assembly according to claim 1, wherein the support comprises first and second substantially parallel elongate portions.

3. A holding assembly according to claim 2, wherein the covering includes positioning ribs to position the support on the covering.

4. A holding assembly according to claim 3, wherein the positioning ribs are arranged between the elongate portions.

5. A holding assembly according to claim, wherein the covering comprises a fastening to fasten the covering to the support.

6. (canceled)

7. A holding assembly according to claim 5, wherein the fastening further includes a hook element to engage a region of the support to secure the covering to the support.

8. A holding assembly according to claim 7, wherein the hook element is arranged to receive said region of the support, and wherein the fastening further comprises a barrier to maintain said region of the support in the hook element.

9. A holding assembly according to claim 8, wherein the support comprises a cross portion extending between the elongate portions, the cross portion being provided at one end of the support, the hook element cooperating with the cross portion to secure the support to the covering.

10. A holding assembly according to claim 1, wherein the support comprises an L-shaped portion for fastening the support to a suspension member, the L-shaped portion being receivable in a hole defined by the suspension member.

11. A holding assembly according to claim 10, wherein the substantially U-shaped portion has first and second limbs, the L-shaped portion being attached to the first limb, and wherein the L-shaped portion comprises an insertion member offset from the first limb of the substantially U-shaped portion.

12. (canceled)

13. A holding assembly according to claim 10, wherein the covering comprises an attachment for attaching the holding assembly to the suspension member, the attachment being provided on the covering.

14. A holding assembly according to claim 13, wherein the attaching arrangement comprises a plurality of attaching members arranged opposite one another on the covering.

15. A holding assembly according to claim 14, wherein the covering has first and second limbs, the first limb of the covering extending along the first limb of the substantially U-shaped portion, and the second limb of the covering extending along the second limb of the substantially U-shaped portion.

16. A holding assembly according to claim 14, wherein the attaching members are arranged in a plurality of pairs of attaching members, the attaching members of each pair being arranged opposite each other.

17. (canceled)

18. (canceled)

19. A holding assembly according to claim 1, wherein the covering comprises a gate to allow the article to be received in the holding assembly, the gate being pivotally connected to the covering for movement between open and closed positions.

20. A holding assembly according to claim 19, wherein the gate comprises a main part connected to the covering, the gate comprising a lock configured to lock the gate in the closed position, the covering defining a receiving aperture to receive the locking member.

21. A suspension arrangement comprising a holding assembly as claimed in claim 1, and a suspension member on which the holding assembly is suspended.

22. A suspension arrangement according to claim 21, wherein the support is attached to the suspension member.

23. A suspension arrangement according to claim 21, wherein the suspension member is elongate and defines a hole, and wherein the support comprises an L-shaped portion for fastening the support to the suspension member, the fastening portion being receivable in the hole defined by the suspension member.

24. A suspension arrangement according to claim 23, wherein the suspension member comprises an elongate main portion defining the hole, the main portion comprising a substantially flat strip.

25. (canceled)
